(19) United States
(12) Patent Application Publication
(10) Pub. No.: US 2025/0313659 A1
(43) Pub. Date: Oct. 9, 2025

(54) METHOD FOR RECOVERING RAW MATERIALS FROM ISOCYANURATE-CONTAINING POLYURETHANE PRODUCTS

(71) Applicant: Covestro Deutschland AG, Leverkusen (DE)

(72) Inventors: Jakob Marbach, Leverkusen (DE); Mirko Ruwisch, Köln (DE); Kai Laemmerhold, Odenthal (DE); Tugrul Nalbantoglu, Aachen (DE); Fatma Tuba Bayram, Aachen (DE)

(21) Appl. No.: 18/855,785

(22) PCT Filed: Apr. 25, 2023
(86) PCT No.: PCT/EP2023/060831

§ 371 Date: Oct. 10, 2024

(30) Foreign Application Priority Data
Apr. 27, 2022 (EP) 22170168.3

(51) Int. Cl. C08G 18/02; C08G 18/09; C08J 11/14; C08J 11/18

(52) U.S. Cl. CPC C08G 18/022; C08G 18/092; C08J 11/14; C08J 11/18

(57) ABSTRACT

The present invention relates to a process for recovering raw materials from isocyanurate-containing polyurethane products, in particular known rigid polyurethane-polyisocyanurate foams (PUR-PIR foams or PIR foams for short). The process has the feature that the isocyanurate-containing polyurethane product is reacted with liquid water at a temperature in the range from 130° C. to 260° C. and at a pressure in the range from 1.0 bar to 100 bar in the presence of a catalyst to obtain a chemolysis product and subsequently the chemolysis product is worked up to obtain (I) an amine corresponding to an isocyanate of the isocyanate component and optionally (II) a polyol of the polyol component or a reaction product of a polyol of the polyol component.

The present invention relates to a process for recovering raw materials from isocyanurate-containing polyurethane products, especially the well-known rigid polyurethane-polyisocyanurate foams (PUR-PIR foams or PIR foams for short). The process is characterized in that the isocyanurate-containing polyurethane product is reacted with liquid water at a temperature in the range from 130° C. to 260° C. and at a pressure in the range from 1.0 bar to 100 bar in the presence of a catalyst to obtain a chemolysis product and subsequently the chemolysis product is worked up to obtain (I) an amine corresponding to an isocyanate of the isocyanate component and optionally (II) a polyol of the polyol component or a reaction product of a polyol of the polyol component.

Polyurethane products enjoy a diversity of applications in industry and in everyday life. Distinctions are typically made between polyurethane foams and what are known as “CASE” products, with “CASE” being a collective term for polyurethane coatings (e.g., paints), adhesives, sealants and elastomers. The polyurethane foams are typically divided into rigid foams and flexible foams. Common to all of these products in spite of their dissimilarity is the basic polyurethane structure which is formed by the polyaddition reaction of a polyfunctional isocyanate and of a polyol and which in the case of a polyurethane based on a diisocyanate O═C═N—R—N═C═O and a diol H—O—R′—O—H (where R and R′ denote organic radicals) may be represented for example as

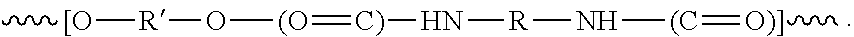

Under certain conditions the isocyanates react not only with the polyols but also with themselves to form isocyanurate structures:

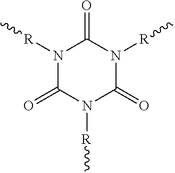

In this way an isocyanurate-containing polyurethane product is formed. This is especially relevant for polyurethane products based on the di- and polyisocyanates of the diphenylmethane series (methylenediphenylene diisocyanate and polymethylenepolyphenylene polyisocyanate, MDI)

Isocyanurate-containing polyurethane products are typically produced as foams and employed especially in the field of building insulation since they offer a higher level of fire safety than polyurethane insulation materials without isocyanurate groups. In applications where flame retardancy plays a lesser role, for example in the insulation of refrigerators, polyurethane products without isocyanurate groups are customary. Since the thermal insulation of buildings is increasing in importance and even the highest quality materials are not capable of unlimited use, the recycling of isocyanurate-containing polyurethane products is also gaining ever greater importance.

The mode of reuse that is the easiest to implement technically is that of incineration, with the heat of combustion released being utilized for other processes, examples being industrial processes. However, this does not allow closure of the raw material loops. Another mode of reuse is so-called “physical recycling”, which sees polyurethane wastes mechanically comminuted and used in the production of new products. This type of recycling naturally has its limits and there has therefore been no lack of attempts to recover the basic raw materials of polyurethane production by retrocleavage of the polyurethane bonds (so-called “chemical recycling”). The raw materials obtainable in such a chemolysis comprise polyols (i.e. H—O—R′—O—H in the above example) and/or reaction products thereof formed in the chemolysis and amines formed by hydrolytic cleavage of the polyurethane bond (i.e. H₂N—R—NH₂ in the above example). After workup amines obtained in this way may be rephosgenated to afford isocyanates (in the above example to O═C═N—R—N═C═O).

Methods of chemical recycling and apparatuses for performance thereof have often appeared in the literature, especially also the patent literature.

Thus for instance Japanese patent application JP 2004-115631 A discloses an apparatus for decomposition of foamed plastics. The foamed plastics are kneaded at elevated temperature during passage through the apparatus. Aminic compounds, polyols and water are described as suitable decomposition reagents. In the case of water as a decomposition reagent (hydrolysis), alkali or alkaline earth metals or compounds thereof, aminic compounds and the like are described as suitable catalysts. Foamed plastics that can be decomposed by means of the apparatus described especially include flexible or rigid polyurethane foams or isocyanurate-containing foams. The use of the apparatus is demonstrated in the examples on the chemolysis of a rigid polyurethane foam from refrigerator insulation with mono- or diethanolamine at 210° C. or 250° C. It is therefore unclear whether the described apparatus can in fact also be successfully applied to the cleavage of isocyanurate-containing foams under the described conditions. The application is clearly focused on the described apparatus in which the foamed plastics are “kneaded” i.e. subjected to great mechanical stresses. Whether and how amines can be isolated from the chemolysis product thus obtained is not disclosed in the application.

DE 24 43 387 A1 describes a process for continuous hydrolytic cleavage of polymer wastes, wherein wastes composed of hydrolyzable plastic material are introduced into a screw apparatus together with water and optionally hydrolysis catalysts, where the mixture of water and plastic wastes is subjected to a temperature of 100° C. to 300° C. at a pressure of to 100 bar for 2 to 100 minutes in a reaction zone with intense mass and heat transfer and the liquid-gas mixture formed in the hydrolysis is continuously conveyed into a die fixedly connected to the screw apparatus, from which the gas escapes via a control valve which maintains constant screw apparatus pressure in the die and the liquid escapes via a control valve that maintains a constant liquid level within the die. The process is demonstrated using the example of cleavage of a flexible, elastic polyurethane foam.

DE 29 02 509 A1 describes a process for producing polyol-containing liquids from polyurethane- and/or polyisocyanurate-containing foam wastes by heating optionally comminuted foam wastes with at least one aliphatic diol of general formula HO—R—OH in which R is a straight-chain or branched alkylene radical having 2 to about 20 carbon atoms whose main chain may be interrupted by one or more oxygen atoms to temperatures of 150° C. to about 220° C. in the presence of a catalyst, wherein the catalyst employed is at least one compound of a metal of transition group IV of the periodic table.

EP 0 011 662 A1 describes the hydrolysis of polyurethanes, especially flexible polyurethane foams, with superheated steam in the presence of basic alkali metal or alkaline earth metal compounds.

EP 0 753 535 A1 is concerned with a process for production of recycled polyols by glycolysis of polyisocyanurates. To this end the polyisocyanurates are reacted with short-chain hydroxyl group-containing compounds in the presence of carrier polyols having an OH number of at most 500 mg KOH/g and a molar mass of at least 450 g/mol.

EP 0 976 719 A1 (also published as U.S. Pat. No. 6,630,517) describes an apparatus and a process for hydrolysis of polyisocyanate derivatives where the polyisocyanate derivative to be cleaved is reacted with liquid water having a temperature of 190° C. to 370° C. at a pressure of 30 to 300 bar. The hydrolysis is carried out without the use of a catalyst. In fact EP 0 976 719 A1 (U.S. Pat. No. 6,630,517) has explicitly sought to avoid the use of catalysts. Polyisocyanate derivatives are to be understood to be compounds comprising at least one isocyanate group or a functional group derived therefrom, for example polyurethanes. In the context of the application polyisocyanate derivatives are likewise compounds which are formed by oligomerization of isocyanate group-containing compounds and which are present in the distillation residues from chemical plants for producing the isocyanate group-containing compounds. Examples of such oligomeric compounds present in the waste streams of a chemical plant for production of isocyanate group-containing compounds include dimers, trimers or higher oligomers, for example carbodiimide, uretdione, urethanimine, isocyanurate and the like. The process is demonstrated in the examples with reference to the hydrolysis of a flexible polyurethane foam, a rigid polyurethane foam and a residue from the production of tolylene diisocyanate (TDI). The polyurethane foams are compressed at elevated temperature prior to the hydrolysis. It is unclear from EP 0 976 719 A1 (U.S. Pat. No. 6,630,517) whether isocyanate group-containing polyurethane products (distinct from residue streams from isocyanate production), especially PUR-PIR foams, are hydrolyzable with this process.

U.S. Pat. No. 3,441,616 describes the recovery of polyether polyols from polyurethane products by hydrolysis at temperatures between 100° C. and 190° C. in the presence of strong bases such as alkali metal or alkaline earth metal oxides or alkali metal or alkaline earth metal hydroxides in a mixture of water and dimethyl sulfoxide, followed by extraction of the polyether polyol formed with a hydrocarbon. The examples describe the hydrolysis of TDI-based polyurethane foams.

CN 111 533 873 A describes a process for recovery of polyurethane screens.

CN 113 429 540 A describes a process for producing a polyurethane thermal insulation material by using a polyol alcoholysis agent to effect decomposition of polyurethane waste.

WO 96/26236 A1 describes a process for separating polymeric materials from a plastic part, especially a motor vehicle part, composed of thermoplastic polymers and at least one thermally curable polymer of polyurethane foam.

WO 2022/042909 A1 describes a process for hydrolysis of polyurethanes in the presence of a base comprising an alkali metal cation and/or an ammonium cation, wherein the base has a pK_{B} value at 25° C. of 1 to 10 and wherein in addition the process employs a (phase transfer) catalyst selected from the group consisting of (i) a quaternary ammonium salt containing an ammonium cation having 6 to 30 carbon atoms and (ii) an organic sulfonate containing at least 7 carbon atoms. The hydrolysis provides polyether polyols and polyamines. The recovery of PIR-containing polyurethanes is not described. A hydrolysis of polyether polyol-based polyurethanes in the presence of strong bases such as the oxides and hydroxides of alkali metals and alkaline earth metals and an activating agent selected from quaternary ammonium salts having at least 15 carbon atoms or organic sulfonates having at least 7 carbon atoms has previously been described in U.S. Pat. No. 5,208,379.

WO 2022/042910 A1 describes a process for hydrolysis of polyurethanes in the presence of a base comprising an alkali metal cation and/or an ammonium cation, wherein the base has a pK_{B} value at 25° C. of less than 1 and wherein in addition the process employs a (phase transfer) catalyst selected from the group consisting of (i) a quaternary ammonium salt containing an ammonium cation having 6 to 14 carbon atoms if the ammonium cation does not comprise a benzyl radical and (ii) a quaternary ammonium salt containing an ammonium cation having 6 to 12 carbon atoms if the ammonium cation comprises a benzyl radical. The hydrolysis provides polyether polyols and polyamines. The recovery of PIR-containing polyurethanes is not described.

WO 2023/275029 A1 describes a process for producing polyurethane foams by reacting an isocyanate component with a polyol component, wherein the polyol component comprises a recycled polyol containing certain aminic and/or phenolic antioxidants in a mass fraction of 0.001% to 10%. The recycled polyol is preferably obtained by a hydrolysis process as described in WO 2022/042909 A1 or WO 2022/042910 A1.

WO 2023/275036 A1 describes a process for producing aromatic and/or aliphatic di- and/or polyisocyanates by phosgenation of di- and/or polyamines obtained by a hydrolysis process as described in WO 2022/042909 A1 or WO 2022/042910 A1.

WO 2023/275038 A1 describes a process for ring hydrogenation of aromatic amines resulting at least partially from a polyurethane decomposition process. A preferred polyurethane decomposition process is a hydrolysis process as described in WO 2022/042909 A1 or WO 2022/042910 A1.

EP 1 149 862 A1 describes a process in which a rigid polyurethane foam from a used refrigerator is pulverized, liquefied by glycolysis or aminolysis and subsequently treated with supercritical or non-supercritical water. The crude product thus obtained is fractionated and used in the production of new refrigerators.

GB 991,387 A describes the hydrolysis of non-volatile polyisocyanate reaction products with superheated steam at 200° C. to 400° C. Non-volatile polyisocyanate reaction products are to be understood as meaning the reaction products of polyisocyanates with compounds comprising active hydrogen atoms (such as polyureas and polyurethanes) and also the products of oligomerization reactions of polyisocyanates (such as isocyanurates and carbodiimides).

U.S. Pat. No. 3,708,440 describes a process for workup of a waste polyisocyanurate foam to obtain a polyol which may be used without further measures as a polyol component in the production of a polyurethane foam. The process comprises heating the waste foam to 175° C. to 250° C. in the presence of (a) an aliphatic diol having 2 to 6 carbon atoms and a boiling point of above about 180° C. and (b) a dialkanolamine having 4 to 8 carbon atoms, wherein the dialkanolamine comprises about 2 to 20 percent by weight of the mixture.

H. Ulrich et al. in Polymer Engineering And Science, 1978, 18, 844-848 describe the glycolysis of polyurethane and (polyurethane) polyisocyanurate foams for recovery of polyols that may be reused in foam production. The introductory part mentions not only glycolysis but also the options of hydrolysis with steam and pyrolysis, both of which are described as disadvantageous, however, since according to the authors they result in complex product mixtures. Thus, separation of the amines formed during a hydrolysis is said not to be practicable while glycolysis is said to result in recoverable polyol mixtures in a single-stage process.

P. N. Gribkova et al. in Polymer Science U.S.S.R., 1980, 22, 299-304 describe the decomposition of polyisocyanurate obtained by polycyclotrimerization of 4,4′-methylenediphenylene diisocyanate (4,4′-mMDI) (i.e. contains no urethane groups). The polyisocyanurate investigated was able to be cleaved inter alia in saturated steam at high temperatures (decomposition commences at temperatures above about 300° C.) without catalyst (i.e. by purely thermal means).

None of the aforementioned processes is entirely satisfactory for the recovery of raw materials from isocyanurate-containing polyurethane products. Especially in terms of the recovery of amines from isocyanurate-containing polyurethane products there remains a lack of practicable processes.

There was therefore a need for further improvements in the field of recovery of raw materials from isocyanurate-containing polyurethane products. It would especially be desirable to recover amines from isocyanurate-containing polyurethane products in order that these may be re-phosgenated to yield the isocyanates after purification.

Taking this requirement into account, the present invention provides a process for recovering raw materials from isocyanurate-containing polyurethane products comprising the steps of:
(A) providing an isocyanurate-containing polyurethane product based on an isocyanate component and a polyol component;
(B) chemolysis (=hydrolysis) of the isocyanurate-containing polyurethane product with liquid water in the absence of an organic solvent or in the presence of an organic solvent inert toward urethane groups and isocyanurate groups
   at a temperature in the range from 130° C. to 260° C., especially to 240° C., preferably 135° C. to 230° C., particularly preferably 140° C. to 220° C., and at a pressure in the range from 1.0 bar to 100 bar, preferably 5.0 bar to 100 bar, especially preferably bar to 80 bar,
   in the presence of a (i.e. with addition of a) catalyst which especially is or comprises none of the following compounds (i) to (ii):
      (i) a quaternary ammonium salt containing an ammonium cation comprising 6 or more carbon atoms, (ii) an organic sulfonate comprising 7 or more carbon atoms,
   to obtain a chemolysis product;
   and
(C) workup of the chemolysis product to obtain
   (I) (at least) one amine corresponding to an isocyanate of the isocyanate component and optionally
   (II) (at least) one polyol of the polyol component or (at least) one reaction product of a polyol of the polyol component.

It has now been found that, entirely surprisingly, the chemolysis of isocyanurate-containing polyurethane products succeeds under the recited conditions and allows recovery of amines as a pure hydrolysis, i.e. without the use of reactive organic solvents.

In the context of the present invention polyurethane products are the polyaddition products of polyfunctional isocyanates (=iscocyanate component of polyurethane production) and polyols (=polyol component of polyurethane production). The invention is concerned with the recovery of polyurethane products which contain isocyanurate structures (see above) in addition to the pure polyurethane basic structure. In addition, other structures, for example structures comprising urea bonds, may also be present and it goes without saying that this does not depart from the scope of the present invention.

In the terminology of the present invention, the term isocyanates encompasses the isocyanates familiar to those skilled in the art in the context of isocyanurate chemistry. It goes without saying that the expression “an isocyanate” also encompass embodiments in which two or more different isocyanates (for example mixtures of different MDI types) were used in the production of the isocyanurate-containing polyurethane product unless explicitly stated otherwise, for instance by means of the wording “precisely one isocyanate”. The entirety of all isocyanates used in the production of the isocyanurate-containing polyurethane product is referred to as the isocyanate component (of the isocyanurate-containing polyurethane product). The isocyanate component comprises at least one isocyanate.

Analogously, the entirety of all polyols used in the production of the isocyanurate-containing polyurethane product is referred to as the polyol component (of the isocyanurate-containing polyurethane product). The polyol component comprises at least one polyol. It will be appreciated that the expression “a polyol” also encompasses embodiments in which two or more different polyols were used in the production of the isocyanurate-containing polyurethane product. Therefore, if reference is made below, for example, to “a polyether polyol” (or “a polyester polyol” etc.), it will be appreciated that this terminology also encompasses embodiments in which two or more different polyether polyols (or two or more different polyester polyols etc.) were employed in the production of the isocyanurate-containing polyurethane product.

An amine corresponding to an isocyanate is the amine that can be phosgenated to obtain the isocyanate according to R-NH₂+COCl₂→R—N═C═O+2 HCl.

According to the invention, the chemolysis of the isocyanurate-containing polyurethane product is carried out as a hydrolysis, namely with liquid water. This is to be understood as meaning that the chemical reaction of the hydrolysis is effected by the action of liquid water on the isocyanurate-containing polyurethane product (in contrast for example to the use of steam). The chemolysis is carried out in the absence of an organic solvent or in the presence of an organic solvent inert toward urethane groups and isocyanurate groups (i.e. the organic solvent does not contribute to the cleavage of urethane groups and/or isocyanurate groups); what is concerned is therefore a “true” hydrolysis and not a hydroglycolysis.

According to the invention, the hydrolysis is carried out in the presence of a catalyst. In the context of the process according to the invention this is to be understood as meaning added catalyst. Depending on the origin of the isocyanurate-containing polyurethane product to be recovered the presence therein of trace amounts of catalytically active concomitants deriving from original production cannot be ruled out. In the context of the present invention it is provided not to rely on such potentially present catalyst residues but rather—in the context of reliable and reproducible reaction management—to add a catalyst for the performing of step (B).

In a particularly preferred embodiment the hydrolysis is carried out in the presence of a(=with addition of a) catalyst which is or comprises none of the following compounds (i) to (ii): (i) a quaternary ammonium salt containing an ammonium cation comprising 6 or more (for example up to 30) carbon atoms, (ii) an organic sulfonate comprising 7 or more (for example up to 25) carbon atoms. The present embodiment therefore excludes addition of quaternary ammonium salts containing an ammonium cation comprising 6 or more carbon atoms (for example (a) quaternary ammonium salts containing an ammonium cation having 6 to 30 carbon atoms, (b) quaternary ammonium salts containing an ammonium cation having 6 to 14 carbon atoms if the ammonium cation does not comprise a benzyl radical, (c) quaternary ammonium salts containing an ammonium cation having 6 to 12 carbon atoms if the ammonium cation comprises a benzyl radical) and organic sulfonates containing at least 7 carbon atoms for chemolysis, i.e. chemolysis is carried out in the absence of the recited compounds. Organic sulfonates are understood to be the salts of organic sulfonic acids with the anion R—SO₃⁻, wherein “R” refers to an organic residue containing the 7 or more carbon atoms.

There now follows a summary of various possible embodiments of the invention:

In a first embodiment of the process according to the invention, which may be combined with all other embodiments, step (A) comprises an extraction of the polyurethane product with an organic solvent which does not react with urethane groups or isocyanurate groups during the extraction.

In a second embodiment of the process according to the invention, which is a particular embodiment of the first embodiment, the organic solvent used in the extraction comprises (especially: is) an aromatic hydrocarbon (especially toluene), a haloaromatic (especially mono- or [preferably: ortho-]dichlorobenzene), an aliphatic ether (especially tetrahydrofuran or [preferably: 1.4-]dioxane), a ketone (especially acetone), an aromatic ether (especially anisole) or a mixture of two or more of the aforementioned organic solvents.

In a third embodiment of the process according to the invention, which is a particular embodiment of the first and second embodiment, the extraction is performed at a temperature in the range from ambient temperature (especially 20° C.) to 180° C., preferably in the range from 50° C. to 180° C. and particularly preferably at ambient pressure (especially 1.0 bar) and the boiling temperature of the organic solvent.

In a fourth embodiment of the process according to the invention, which may be combined with all other embodiments, step (A) comprises a mechanical comminution of the polyurethane product.

In a fifth embodiment of the process according to the invention, which may be combined with all other embodiments, the catalyst comprises (especially: is) a hydroxide, a carbonate, a hydrogencarbonate, a phosphate, a hydrogenphosphate, a carboxylate, an alkoxide, a metal oxide or a mixture of two or more of the aforementioned catalysts.

In a sixth embodiment of the process according to the invention, which is a particular embodiment of the fifth embodiment, the catalyst comprises (especially: is) an alkali metal or alkaline earth metal salt of a hydroxide, a carbonate, a hydrogencarbonate, a phosphate, a hydrogenphosphate, a carboxylate or an alkoxide.

In a seventh embodiment of the process according to the invention, which may be combined with all other embodiments, provided these are not limited to solvent-free chemolysis, the chemolysis is performed in the presence of an organic solvent inert toward urethane groups and isocyanurate groups.

In an eighth embodiment of the process according to the invention, which is a particular embodiment of the seventh embodiment, in step (B) the polyurethane product is initially charged in the organic solvent inert toward urethane groups and isocyanurate groups and the water is added gradually.

In a ninth embodiment of the process according to the invention, which is a particular embodiment of the seventh and eighth embodiments, the organic solvent inert toward urethane groups and isocyanurate groups comprises (especially: is) dimethyl sulfoxide, N,N-dimethylformamide, N-methyl-2-pyrrolidone, dichlorobenzene (especially the ortho-isomer), trichlorobenzene, ethylmethylbenzene (especially 1-ethyl-2-methylbenzene), mesitylene, (especially n-)decane, (especially n-)undecane and/or (especially n-)dodecane.

In a tenth embodiment of the process according to the invention, which may be combined with all other embodiments, provided these are not limited to a chemolysis in the presence of a solvent, the chemolysis is carried out in the absence of an organic solvent.

In an eleventh embodiment of the process according to the invention, which is a particular embodiment of the eighth and ninth embodiments, the chemolysis is performed at a pressure in the range from 1.0 bar to <5.0 bar, preferably 1.0 bar to 1.5 bar, particularly preferably 1.0 bar to 1.2 bar and especially at ambient pressure (especially 1.0 bar).

In a twelfth embodiment of the process according to the invention, which is a particular embodiment of the tenth embodiment, the chemolysis is performed without pressure equalization under autogenous pressure, especially in the range from 5.0 bar to 100 bar, preferably 10 bar to 80 bar.

In a thirteenth embodiment of the process according to the invention, which is a particular embodiment of the first to twelfth embodiment, in step (C) the chemolysis product is cooled (by active cooling or allowing to cool) to precipitate a first solid organic (amine) phase, this is followed by a liquid-solid phase separation into a first aqueous phase and the first solid organic (amine) phase and the first solid organic (amine) phase is subjected to further workup to obtain the amine.

In a fourteenth embodiment of the process according to the invention, which is a particular embodiment of the thirteenth embodiment, the further workup of the first solid organic (amine) phase comprises a washing thereof with an aqueous washing liquid.

In a fifteenth embodiment of the process according to the invention, which is a particular embodiment of the thirteenth and fourteenth embodiments, the optionally washed first solid organic (amine) phase is dissolved in an organic solvent to obtain a first liquid organic (amine) phase which is subjected to further workup to obtain the amine.

In a sixteenth embodiment of the process according to the invention, which is a further particular embodiment of the first to the twelfth embodiments, in step (C) the chemolysis product is extracted with an organic solvent, this is followed by a liquid-liquid phase separation into a first aqueous phase and a first liquid organic (amine) phase and the first liquid organic (amine) phase is subjected to further workup to obtain the amine.

In a seventeenth embodiment of the process according to the invention, which is a particular embodiment of the fifteenth and sixteenth embodiments, the further processing of the first liquid organic (amine) phase comprises a washing thereof with an aqueous washing liquid.

In an eighteenth embodiment of the process according to the invention, which is a particular embodiment of the fifteenth to seventeenth embodiments, the optionally washed first liquid organic (amine) phase is extracted with an aqueous mineral acid, subsequently a phase separation into a second liquid organic phase and a second aqueous (protonated amine-containing) phase is performed and this is followed by neutralization or alkalinization of the second aqueous phase to precipitate a second solid organic (amine) phase and this is followed by a workup of the second solid organic (amine) phase to obtain the amine.

In a nineteenth embodiment of the process according to the invention, which is a particular embodiment of the eighteenth embodiment, the second solid organic (amine) phase is separated by liquid-solid phase separation or taken up in an organic solvent.

A twentieth embodiment of the process according to the invention, which is a particular embodiment of the eighteenth and nineteenth embodiments, comprises step (C.II), wherein step (C.II) comprises a workup of the second liquid organic phase by distillative separation of organic solvent to retain an alcohol phase and this is followed by a purification of the alcohol phase by distillation or stripping.

A twenty-first embodiment of the process according to the invention, which is a particular embodiment of the thirteenth to twentieth embodiments, comprises step (C.II), wherein step (C.II) comprises a workup of the first aqueous phase by distillative separation of water to retain an alcohol phase and this is followed by a purification of the alcohol phase by distillation or stripping.

In a twenty-second embodiment of the process according to the invention, which can be combined with all other embodiments, the isocyanate component comprises methylenediphenylene diisocyanate, polymethylenepolyphenylene polyisocyanate or a mixture of methylenediphenylene diisocyanate and polymethylenepolyphenylene polyisocyanate. The isocyanate component preferably comprises no tolylene diisocyanate and particularly preferably no further isocyanates whatsoever in addition to these.

In a twenty-third embodiment of the process according to the invention, which may be combined with all other embodiments, the polyol component comprises a polyether polyol, a polyester polyol, a polyether ester polyol, a polyether carbonate polyol or a mixture of two or more of the aforementioned polyols.

In a twenty-fourth embodiment of the process according to the invention, which may be combined with all other embodiments, the isocyanurate-containing polyurethane product provided in step (A) is a polyurethane foam, especially a rigid polyurethane foam, preferably derived from a building insulation.

In a twenty-fifth embodiment of the process according to the invention, which may be combined with all other embodiments, the chemolysis is performed in a stirred tank reactor.

In a twenty-sixth embodiment of the process according to the invention, which may be combined with all other embodiments, the amine obtained in step (C.I) is phosgenated to the corresponding isocyanate in a step (D).

In a twenty-seventh embodiment of the process according to the invention, which may be combined with all other embodiments, the catalyst comprises none of the following compounds (i) to (ii):
(i) a quaternary ammonium salt containing an ammonium cation comprising 6 or more carbon atoms, (ii) an organic sulfonate comprising 7 or more carbon atoms.

The embodiments outlined briefly above and further possible configurations of the invention are more particularly elucidated hereinbelow. All the above-described embodiments and the further configurations of the invention described below are mutually and collectively combinable as desired unless the opposite is clearly apparent from the context to a person skilled in the art or is expressly stated.

### Preparation of the Chemical Recycling

Step (A) of the process according to the invention comprises providing the isocyanurate-containing polyurethane product to be chemically recycled. Isocyanurate-containing polyurethane products in the context of the present invention are especially polyurethane products whose infrared spectra in the spectral range from 1650 cm⁻¹ to 1800 cm⁻¹ (range of C═O stretching vibration) have a signal maximum at a wavenumber of 1712 cm⁻¹ or less.

This may in principle be any kind of isocyanurate-containing polyurethane product. However, preference is given to polyurethane foams, especially rigid polyurethane foams, preferably deriving from a building insulation. A rigid polyurethane foam is a highly crosslinked thermoset plastic which is foamed to afford a cellular construct of low raw material density (especially in the range from 20 kg/m³ to 90 kg/m³, preferably 30 kg/m³ to 45 kg/m³, determined according to DIN EN ISO 845:2009-10) and low thermal conductivity (generally in the range from 0.016 W/(m−K) to 0.030 W/(m−K) determined according to DIN 52616 1977-11). It is generally closed-celled and exhibits a relatively high deformation resistance under compressive stress. The thermoset character is reflected in the fact that the foam is not fusible and has a high softening point and good resistance to chemicals and solvents. Rigid polyurethane foams especially have a compressive strength at 10% determined according to DIN EN 826 2013-05 of 50 kPa to 300 kPa and a tensile strength determined according to EN 1607 2013-05 of 30 kPa to 250 kPa.

Preference is moreover given to polyurethane products which regarding the isocyanate component are based on an isocyanate selected from the group consisting of methylenediphenylene diisocyanate (“monomeric MDI”; mMDI), polymethylenepolyphenylene polyisocyanate (“polymeric MDI”; pMDI) and a mixture of methylenediphenylene diisocyanate and polymethylenepolyphenylene polyisocyanate (hereinbelow referred to collectively as MDI). These are produced by phosgenation of the corresponding amines (methylenediphenylenediamine [“monomeric MDA”; mMDA], polymethylenepolyphenylenepolyamine (“polymeric MDA”; pMDA)) or a mixture of methylenediphenylenediamine and polymethylenepolyphenylenepolyamine [hereinbelow referred to collectively as MDA]).

Preference is moreover given to polyurethane products which regarding the polyol component are based on a polyol selected from polyether polyols, polyester polyols, polyether ester polyols, polyether carbonate polyols or a mixture of two or more of the recited polyols. Particular preference is given to polyester polyols and polyether ester polyols, especially in each case in admixture with polyether polyols.

Step (A) preferably comprises preparatory steps for the cleavage of the urethane bonds and isocyanurate bonds in step (B). These preferably comprise mechanical comminution of the isocyanurate-containing polyurethane products. Such preparatory steps are known to those skilled in the art.

Especially isocyanurate-containing polyurethane products from a building insulation regularly contain additives, especially flame retardants, but also stabilizers and activators. It has proven advantageous to remove these in an extraction step before commencing with the chemical recycling in step (B). To this end, the preferably previously comminuted isocyanurate-containing polyurethane foam is extracted with an organic solvent which does not react with urethane groups or isocyanurate groups during the extraction. This is ensured either by using a solvent that is fundamentally chemically inert toward urethane groups and isocyanurate groups (preferred) or by selecting a temperature and/or extraction time that is low enough to ensure that chemical reaction does not yet occur to a significant extent. Organic solvents that have proven advantageous include especially aromatic hydrocarbons (especially toluene), haloaromatics (especially monochlorobenzene or [preferably: ortho-]dichlorobenzene, wherein dichlorobenzene, preferably employed as the ortho-isomer, is more preferred than monochlorobenzene), aliphatic ethers (especially tetrahydrofuran or [preferably: 1.4-]dioxane), ketones (especially acetone), aromatic ethers (especially anisole) or a mixture of two or more of the aforementioned solvents. Haloaromatics are preferred. Suitable temperatures for the extraction are for example in the range from ambient temperature (room temperature, especially 20° C.) to 180° C., preferably in the range from 50° C. to 180° C. The extraction may especially be performed at ambient pressure and the boiling temperature of the selected organic solvent (“under reflux”). Once extraction is complete, the isocyanurate-containing polyurethane product to be cleaved is separated from the extraction solvent by solid-liquid separation, especially filtration, and preferably washed, especially with one of the aforementioned organic solvents (it is possible but not necessary to employ the same solvent as in the extraction). Adhering solvent residues are preferably removed by drying before performance of step (B). However, the less preferred embodiment using reactive solvents (for example alcohols) for the extraction and/or washing provides for removal of said solvent prior to step (B).

### Chemical Cleavage of Urethane Bonds and Isocyanurate Bonds

Step (B) comprises the chemolysis of the isocyanurate-containing polyurethane product with liquid water. According to the invention, this hydrolysis is carried out at a temperature in the range from 130° C. to 260° C., especially to 240° C., preferably 135° C. to 230° C., particularly preferably 140° C. to 220° C., and at a pressure in the range from 1.0 bar to 100 bar, preferably 5.0 bar to 100 bar, particularly preferably 10 bar to 80 bar, in the presence of a catalyst.

Catalysts that have proven advantageous include hydroxides, carbonates, hydrogencarbonates, phosphates, hydrogenphosphates, carboxylates, alkoxides and metal oxides. Although not preferable it is also possible to employ different catalysts as mixtures. It is preferable to employ catalysts in the form of alkali metal or alkaline earth metal salts.

As mentioned hereinabove, the chemolysis may be performed in the presence of an organic solvent inert toward urethane groups and isocyanurate groups. Such solvents that have proven advantageous especially include dimethyl sulfoxide, N,N-dimethylformamide, N-methyl-2-pyrrolidone, dichlorobenzene (especially the ortho-isomer), trichlorobenzene, ethylmethylbenzene (especially 1-ethyl-2-methylbenzene), mesitylene, (especially n-)decane, (especially n-)undecane and (especially n-)dodecane. When using an organic solvent it is possible to initially charge (to dissolve or suspend) the isocyanurate-containing polyurethane product to be cleaved in the solvent, to heat the reaction mixture to the reaction temperature and then to add the water gradually such that the temperature does not fall excessively, especially does not fall by more than 15.0° C. In this procedure the water reacts to effect hydrolysis of the PUR and PIR bonds fast enough to ensure that it does not evaporate to an extent that impairs the reaction. In this case the reaction is typically performed at low pressures of preferably 1.0 bar to <5.0 bar, preferably 1.0 bar to 1.5 bar, particularly preferably 1.0 bar to 1.2 bar and especially at ambient pressure.

However, it is also possible and preferable to perform the reaction completely without organic solvent. This facilitates the workup. In this case it has proven advantageous to perform the hydrolysis without pressure equalization in a pressure-resistant reactor under autogenous pressure, especially in the range from 5.0 bar to 100 bar, preferably 10 bar to 80 bar. In this case the relatively high pressure ensures that the chemolysis is effected with liquid water.

The chemolysis is thus especially performed such that
step (B) comprises initially charging the polyurethane product in an organic solvent inert toward urethane groups and isocyanurate groups and gradually adding the water, wherein a pressure of 1.0 bar to <5.0 bar, preferably 1.0 bar to 1.5 bar, particularly preferably 1.0 bar to 1.2 bar and especially atmospheric pressure is maintained,
   or
step (B) comprises reacting the polyurethane product with the water in the absence of an organic solvent without pressure equalization under autogenous pressure, especially in the range from 5.0 bar to 100 bar, preferably 10 bar to 80 bar.

Having regard to the employable apparatuses, all reactor types familiar in the art are suitable in principle. Stirred tank reactors are preferred.

### Workup of the Chemolysis Product

Step (C) comprises workup of the chemolysis product obtained in step (B) to obtain (1) (at least) one amine corresponding to an isocyanate of the isocyanate component and optionally (11) (at least) one polyol of the polyol component or (at least) one reaction product of a polyol of the polyol component.

Once hydrolysis is complete, the chemolysis product is initially cooled (by active cooling or allowing to cool) to precipitate a first solid organic (amine) phase. The term “solid phase” is not limited to “crystalline solids” in the context of the present invention. Pasty, “clay-like” phases are often generated and are subsumed under the generic term “solid phase” in the terminology used here. The first solid organic (amine) phase is separated from the chemolysis product by a liquid-solid phase separation (especially filtration) to retain a first aqueous phase. The obtained first solid organic phase is subjected to further workup to obtain the amine.

This further workup preferably comprises a washing with an aqueous washing liquid. It is moreover preferable to dissolve the optionally washed, first solid organic phase in an organic solvent to obtain a first liquid organic amine phase which is subjected to further workup to obtain the amine. Suitable organic solvents for this purpose especially include halogenated aliphatic hydrocarbons (such as especially dichloromethane and chloroform), halogenated aromatic hydrocarbons (such as especially monochlorobenzene and (preferably ortho-)dichlorobenzene, cycloaliphatic alcohols (such as especially cyclohexanol) and aromatic ethers (such as especially anisole).

Alternatively to the liquid-solid phase separation of the chemolysis product, it is also possible to extract the chemolysis product in its entirety with an organic solvent followed by a liquid-liquid phase separation into a first aqueous phase and a first liquid organic (amine) phase. Suitable organic solvents for this purpose especially include halogenated aliphatic hydrocarbons (such as especially dichloromethane and chloroform), halogenated aromatic hydrocarbons (such as especially monochlorobenzene and (preferably ortho-)dichlorobenzene, cycloaliphatic alcohols (such as especially cyclohexanol) and aromatic ethers (such as especially anisole).

Irrespective of how precisely the first liquid organic phase was obtained this is subjected to further workup to obtain the amine. This further workup preferably initially comprises a washing with an aqueous washing liquid.

The optionally washed first liquid organic phase is then preferably extracted with an aqueous mineral acid followed by a phase separation into a second liquid organic phase and a second aqueous (protonated amine-containing) phase. This second aqueous phase is neutralized or alkalinized (pH preferably from 9.0 to 14, preferably 10 to 14) by precipitation of a second solid organic (amine) phase. The resulting second solid organic phase is subjected to further workup to obtain the amine.

To this end it is preferable to separate the second solid organic phase initially by liquid-solid phase separation (especially filtration). Especially when the nature of this solid phase is such that a liquid-solid phase separation is performable only with difficulty it may also be directly taken up in an organic solvent and separated from the aqueous constituents by liquid-liquid phase separation. Suitable organic solvents for this purpose especially include halogenated aliphatic hydrocarbons (such as especially dichloromethane and chloroform), halogenated aromatic hydrocarbons (such as especially monochlorobenzene and (preferably ortho-)dichlorobenzene, cycloaliphatic alcohols (such as especially cyclohexanol) and aromatic ethers (such as especially anisole). After evaporation of the solvent the second solid organic phase is retained. This is preferably washed and dried. The solid obtained in this way contains the amine which may be returned to a phosgenation to afford the corresponding isocyanate. Such a phosgenation may be performed by a process known from the prior art (step (D)). Such a process is described for example in WO 2017/055311 A1 (see especially page 15, line 10 to page 19, line 17).

It goes without saying that the polyol component of the isocyanurate-containing polyurethane product also represents a product of value which is preferably subjected to material recovery to the greatest possible extent. The nature of the raw material to be recovered depends here on the nature of the polyol component originally employed. While pure polyether polyols may be recovered as such, polyols with more reactive functional groups (such as especially ester groups) undergo hydrolytic cleavage in step (B). However, the resulting low molecular weight or oligomeric reaction products are likewise valuable raw materials that may be used in the production of new polyols.

Polyols and/or their reaction products are obtainable through workup of the first aqueous phase. The aforementioned second liquid organic phase may also contain these in substantial proportions.

Workup of the first aqueous phase to obtain the polyols and/or their reaction products preferably comprises a distillative separation of water to retain an alcohol phase, followed by purification of the alcohol phase by distillation or stripping.

Workup of the second liquid organic phase to obtain the polyols and/or their reaction products preferably comprises a distillative separation of organic solvent to retain an alcohol phase, in turn followed by purification of the alcohol phase by distillation or stripping.

### EXAMPLES

Index: This refers to the molar ratio of NCO groups to NCO-reactive groups in a formulation multiplied by 100.
Amine number: Determination of the amine number was carried out according to EN ISO 9702 (August 1998).

### Chemicals

Desmodur VP.PU 1806 from Covestro Deutschland AG, mixture of diphenylmethane 4,4′-diisocyanate and diphenylmethane 2,4′-diisocyanate having an NCO content of 31.4% by mass
Desmodur 44V70L from Covestro Deutschland AG, polymeric MDI having an NCO content of 30% to 32% by weight
Desmophen 2382 from Covestro Deutschland AG, aromatic polyester polyol having an OH number of 240 mg KOH/g
Desmophen V657 from Covestro Deutschland AG, reactive trifunctional polyether polyol having an OH number of 255±15 mg KOH/g, an acid number of at most 0.35 mg KOH/g and a viscosity at 25° C. of (265±20) mPa-s
Additive 1132 from Covestro Deutschland AG, reaction product of phthalic anhydride and diethylene glycol having an acid number of 89 mg KOH/g
Stabilizer 21AS08 Silicone-polyether copolymer having an OH number of 12 mg KOH/g from Covestro Deutschland AG
Desmorapid 1792 Potassium acetate, 25% by mass in diethylene glycol (DEG)
n-Pentane from Sigma Aldrich
Dimethyl sulfoxide from Sigma Aldrich
Diethylene glycol from Brenntag GmbH
Potassium hydroxide from Sigma Aldrich
Potassium phosphate from Sigma Aldrich
Potassium carbonate from Sigma Aldrich

### Production of Model Substances

### Model Substance 1

In a 250 ml four-necked flask fitted with a gas inlet, reflux condenser, stirrer and dropping funnel 172.1 g of Desmodur VP.PU 1806 were initially charged, blanketed with nitrogen and heated to 80° C. with stirring. To this solution, 77.9 g of Desmophen 2382 were added in such a way that the temperature did not exceed 80° C. Once addition was complete the mixture was stirred at 80° C. for 2 hours. 200 g of the resulting NCO-containing prepolymer were subsequently admixed with 1 g of Desmorapid 1792, mixed in a Speedmixer and subsequently poured out onto an aluminum sheet and cured at 80° C. overnight in an oven to convert the excess NCO groups.

### Production of a PIR-Containing Rigid Foam

The PIR-containing foam was produced as shown in table 1 by hand mixing on a laboratory scale in test packets having a square base area with a side length of 20 cm. The polyol component containing the polyols was initially charged together with the additives and catalysts. Shortly before mixing the polyol component was temperature-controlled to 23° C. to 25° C. while the polyisocyanate component was brought to a temperature of 30° C. to 35° C. The polyisocyanate component was subsequently added with stirring to the polyol mixture which had previously been admixed with the amount of pentane necessary to achieve an apparent core density of about 38 kg/m³. The mixing time was 6 sec and the mixing speed of the Pendraulik stirrer was 4200 min⁻¹. The foam was then stored at 20° C. to 23° C. for a further 24 hours so as to allow postreaction.

TABLE 1
Formulation of the PIR-containing rigid PUR foam

| | | |
|---|---|---|
| Desmophen 2382 | [parts] | 63.8 |
| Desmophen V657 | [parts] | 5.0 |
| PU additive 1132 | [parts] | 2.2 |
| Stabilizer 21AS08 | [parts] | 4.0 |
| Desmorapid 1792 | [parts] | 5.0 |
| n-Pentane | [parts] | 13.8 |
| Desmodur 44V70L | [parts] | 191.3 |
| Index | [—] | 350 |

### Hydrolysis at Atmospheric Pressure

### Example 1 (Inventive)

In a 50 ml two-necked round-bottom flask 7.5 g of model substance 1 and 2.0 g of potassium hydroxide were initially charged in 7.5 g of dimethyl sulfoxide and heated to 140° C. with stirring. 5 ml of water were added to the reaction mixture in respective 1.0 ml portions. After each addition of water the mixture was left stirring until the reaction mixture had again attained the reaction temperature. A further 2.9 ml of water were then added. Once reaction was complete the reaction mixture boiled at about 120° C. and could not be heated further. The amine-containing phase was precipitated by adding 100 ml of water and separated from the reaction mixture by filtration. The pasty filter residue was washed with water, dried under vacuum and then characterized by amine number.

Amine number=520 mg KOH/g.

### Example 2 (Comparative—Hydroglycolysis)

In a 50 ml two-necked round-bottom flask fitted with a thermometer and an intensive cooler 3.3 g of pulverized PIR foam (produced as described above), 15.0 g of diethylene glycol and 1.92 g of potassium hydroxide were initially charged. The flask contents were heated to 140° C. Water was gradually added. Water addition was carried out in small steps and so the temperature of the reaction mixture did not fall below 140° C. After addition of 0.8 g of water a further 4.2 g of pulverized PIR foam (PS 436) were added. The foam went into solution after a few moments. A clear orange liquid was obtained in the flask bottom. A further 4.8 g of water were gradually added. The mixture was then stirred for 2.4 h. The total reaction time was 4 h. The reaction mixture was added to 400 g of water. A dark-brown, pasty solid settled out of the aqueous phase and was separated by decanting. The residue was washed with water and dried under vacuum. Amine number titration gave a value of only 475 mg KOH/g.

### Pressure Hydrolysis

### Example 3 (Inventive)

In a 2.1 L pressure autoclave 600 ml of demineralized water and 25 g of pulverized PIR foam (produced as described above) and 50 g of potassium hydroxide (KOH) flakes were initially charged. The reactor contents were heated to 160° C. for 5.5 h and then cooled to room temperature. A dark-brown, pasty solid settled out of the aqueous phase and was separated by decanting. The residue was washed with water and dried under vacuum. Amine number titration gave a value of 510 mg KOH/g.

### Example 4 (Comparative Example at Excessively Low Temperature)

The experiment was carried out analogously to example 3. However, hydrolysis was performed at 120° C. for 15.5 h. The residue was washed with water and dried under vacuum. An amine number was not determinable due to insolubility.

### Example 5 (Inventive)

The experiment was carried out analogously to example 3. However, hydrolysis was performed at 220° C. for 1.5 h. A dark-brown, pasty solid settled out of the aqueous phase and was separated by decanting. The residue was washed with water and dried under vacuum. Amine number titration gave a value of 533 mg KOH/g.

### Example 6 (Inventive)

In a 2.1 L pressure autoclave 600 ml of demineralized water and 25 g of pulverized PIR foam (produced as described above) and 50 g of potassium phosphate were initially charged. The reactor contents were heated to 160° C. for 6 h and then cooled to room temperature. A dark-brown, pasty solid settled out of the aqueous phase and was separated by decanting. The residue was washed with water and dried under vacuum. Amine number titration gave a value of 510 mg KOH/g.

### Example 7 (Comparison Example without Catalyst)

In a 2.1 L pressure autoclave 600 ml of demineralized water and 25 g of pulverized PIR foam (produced as described above) were initially charged. The reactor contents were heated to 200° C. for 7 h and then cooled to room temperature. A brownish-yellow powder settled out of the aqueous phase and was separable by filtration. The residue was washed with water and dried under vacuum. Amine number titration gave a value of 295 mg KOH/g.

### Example 8 (Inventive, with Extraction Before Hydrolysis)

260 g of a pulverized PIR foam (produced as described above) were heated for 4 h under reflux in ortho-dichlorobenzene, then filtered, washed with acetone and dried in a drying cabinet. 260 g of the extracted foam and 65 g of potassium carbonate were initially charged in a 2.1 L pressure autoclave together with 1500 ml of demineralized water. The reactor contents were heated to 220° C. for 4.25 h and then cooled to room temperature. A dark-brown, pasty solid settled out of the aqueous phase and was taken up in chloroform and washed twice with water. The organic chloroform phase was washed with 10% aqueous HCl. The aqueous phase was subsequently washed with chloroform and adjusted to a pH of 10 with KOH flakes. The resulting precipitate was taken up in chloroform. Removal of the solvent afforded a brownish, pasty solid. Amine number titration gave a value of 515 mg KOH/g.

### Example 9 (Comparative Example without Catalyst and with Extraction Before Hydrolysis)

25 g of a pulverized PIR foam (produced as described above) were heated for 4 h under reflux in ortho-dichlorobenzene, then filtered, washed with acetone and dried in a drying cabinet. 25 g of the extracted PIR foam were initially charged in a 2.1 L pressure autoclave together with 600 ml of demineralized water. The reactor contents were heated to 220° C. for 5.5 h and then cooled to room temperature. A dark-brown, pasty solid settled out of the aqueous phase and was taken up in chloroform and washed twice with water. The organic chloroform phase was washed twice with 10% aqueous HCl. The aqueous phase was washed with chloroform and adjusted to a pH of 10 with KOH flakes. The resulting precipitate was taken up in chloroform. Removal of the solvent afforded a brownish, pasty solid which was dried under vacuum. Amine number titration gave a value of 260 mg KOH/g.

TABLE 2
Pressure hydrolysis of isocyanurate-containing PUR foams (produced as described above)

| | | Example no.: | | | | | | |
|---|---|---|---|---|---|---|---|---|
| | | | 4 | | | 7 | | 9 |
| | | 3 | (comparative) | 5 | 6 | (comparative) | 8 | (comparative) |
| Catalyst: | | KOH | KOH | KOH | K₃PO₄ | — | K₂CO₃ | — |
| Cat. | Mass % | 200 | 200 | 200 | 200 | — | 25 | — |
| conc. | based | | | | | | | |
| | on the | | | | | | | |
| | foam | | | | | | | |
| Temp. | ° C. | 160 | 120 | 220 | 160 | 200 | 220 | 220 |
| Reaction | h | 5.5 | 15.5 | 1.5 | 5.9 | 7 | 4.25 | 5.5 |
| time | | | | | | | | |
| Amine | mg | 510 | n.d. | 533 | 510 | 295 | 515 | 260 |
| number | KOH/g | | | | | | | |

The results in table 2 show that at excessively low temperature incomplete reaction occurs (example 4). At temperatures of 220° C. products with particularly advantageous amine numbers are obtained (example 5). If the hydrolysis is performed in the absence of a catalyst incomplete reaction likewise occurs and even at relatively long reaction times and high temperature only products of low amine number are obtained (example 7 and example 9).

### Pressure Hydrolysis at High Temperature (250° C.)

### Compression of the Foam (for Examples 10 and 11)

In a heatable hydraulic press the foam was compressed at 160° C. for 10 minutes. The employed press initially exerted a force of 11 kN which was reduced to 6 kN over time.

### Example 10 (Comparative Example without Catalyst and with Compression Before Hydrolysis)

In a 2.0 L pressure autoclave from Büchi AG 180 ml of demineralized water and 7.5 g of compressed PIR foam (produced as described above) were initially charged. The reactor contents were heated to 250° C. for 1.5 h and then cooled to room temperature. A dark-brown, pasty solid settled out of the aqueous phase and was taken up in chloroform and washed twice with water. The organic chloroform phase was washed twice with 10% aqueous HCl. The aqueous phase was washed with chloroform and adjusted to a pH of 10 with KOH flakes. The resulting precipitate was taken up in chloroform. Removal of the solvent afforded a brownish, pasty solid which was dried under vacuum. Amine number titration gave a value of 278 mg KOH/g.

### Example 11 (Inventive; with Compression Before Hydrolysis)

In a 2.0 L pressure autoclave from Büchi AG 180 ml of demineralized water and 7.5 g of compressed PIR foam (produced as described above) and also 1.88 g of potassium carbonate were initially charged. The reactor contents were heated to 250° C. for 1.5 h and then cooled to room temperature. A dark-brown, pasty solid settled out of the aqueous phase and was taken up in chloroform and washed twice with water. The organic chloroform phase was washed twice with 10% aqueous HCl. The aqueous phase was washed with chloroform and adjusted to a pH of 10 with KOH flakes. The resulting precipitate was taken up in chloroform. Removal of the solvent afforded a brownish, pasty solid which was dried under vacuum. Amine number titration gave a value of 534 mg KOH/g.

### Example 12 (Inventive; without Compression Before Hydrolysis)

In a 2.0 L pressure autoclave from Büchi AG 180 ml of demineralized water and 7.5 g of powdered (uncompressed) PIR foam (produced as described above) and also 1.88 g of potassium carbonate were initially charged. The reactor contents were heated to 250° C. for 1.5 h and then cooled to room temperature. A dark-brown, pasty solid settled out of the aqueous phase and was taken up in chloroform and washed twice with water. The organic chloroform phase was washed twice with 10% aqueous HCl. The aqueous phase was washed with chloroform and adjusted to a pH of 10 with KOH flakes. The resulting precipitate was taken up in chloroform. Removal of the solvent afforded a brownish, pasty solid which was dried under vacuum. Amine number titration gave a value of 508 mg KOH/g.

TABLE 3
Pressure hydrolysis of isocyanurate-containing PUR foams
at high temperature (produced as described above)

| | | Example no.: | | |
|---|---|---|---|---|
| | | 10 | | |
| | | (comparative) | 11 | 12 |
| Compression: | | Yes | Yes | No |
| Catalyst: | | — | K₂CO₃ | K₂CO₃ |
| Cat. | Mass % based | — | 25 | 25 |
| conc. | on the foam | | | |
| Temp. | ° C. | 250 | 250 | 250 |
| Pressure | bar | 36 | 36 | 36 |
| Reaction | h | 1.5 | 1.5 | 1.5 |
| time | | | | |
| Amine | mg KOH/g | 278 | 534 | 508 |
| number | | | | |

The reaction conditions in example 10 correspond to the reaction conditions described in claim 1 of U.S. Pat. No. 6,630,517 (temperature in the range from 190° C. to 370° C. and pressure in the range from 30 to 300 bar). The foam was also compressed before the hydrolysis (the examples of U.S. Pat. No. 6,630,517 likewise comprised performing a compression before the hydrolysis). Example 10 shows that the process described in U.S. Pat. No. 6,630,517 gives poor results for an isocyanurate-containing PUR foam.

1. A process for recovering raw materials from isocyanurate-containing polyurethane products comprising:
(A) providing an isocyanurate-containing polyurethane product based on an isocyanate component and a polyol component;
(B) conducting chemolysis of the isocyanurate-containing polyurethane product with liquid water in the absence of an organic solvent or in the presence of an organic solvent inert toward urethane groups and isocyanurate groups, the chemolysis being conducted (i) at a temperature of 130° C. to 260° C., (ii) at a pressure of 1.0 bar to 100 bar, and (iii) in the presence of a catalyst, to obtain a chemolysis product; and
(C) working up the chemolysis product to obtain:
(I) an amine corresponding to an isocyanate of the isocyanate component, and optionally
(II) a polyol of the polyol component or a reaction product of a polyol of the polyol component.

2. The process as claimed in claim 1, wherein step (A) comprises an extraction of the polyurethane product with an organic solvent which does not react with urethane groups or isocyanurate groups during extraction.

3. The process as claimed in claim 2, wherein the organic solvent used in the extraction comprises an aromatic hydrocarbon, a haloaromatic, an aliphatic ether, a ketone, an aromatic ether or a mixture of any two or more thereof.

4-5. (canceled)

6. The process as claimed in claim 1, wherein step (A) comprises a mechanical comminution of the polyurethane product.

7. The process as claimed in claim 1, wherein the catalyst comprises a hydroxide, a carbonate, a hydrogencarbonate, a phosphate, a hydrogenphosphate, a carboxylate, an alkoxide, a metal oxide or a mixture of any two or more thereof.

8-14. (canceled)

15. The process as claimed in claim 1, wherein in step (C) the chemolysis product is cooled to precipitate a first solid organic phase, which is followed by a liquid-solid phase separation into a first aqueous phase and the first solid organic phase, wherein the first solid organic phase is subjected to further workup to obtain the amine.

16. (canceled)

17. The process as claimed in claim 15, wherein the first solid organic phase, optionally after washing with an aqueous washing liquid, is dissolved in an organic solvent to obtain a first liquid organic phase which is subjected to further workup to obtain the amine.

18. The process as claimed in claim 1, wherein in step (C) the chemolysis product is extracted with an organic solvent, which is followed by a liquid-liquid phase separation into a first aqueous phase and a first liquid organic phase, wherein the first liquid organic phase is subjected to further workup to obtain the amine.

19. (canceled)

20. The process as claimed in claim 17, wherein the first liquid organic phase, optionally after washing with an aqueous washing liquid, is extracted with an aqueous mineral acid, subsequently a phase separation into a second liquid organic phase and a second aqueous phase is performed, which is followed by neutralization or alkalinization of the second aqueous phase to precipitate a second solid organic phase, which is followed by a workup of the second solid organic phase to obtain the amine.

21. (canceled)

22. The process as claimed in claim 20, comprising step (C.II), which comprises working up the second liquid organic phase by distillative separation of organic solvent to retain an alcohol phase, which is followed by a purification of the alcohol phase by distillation or stripping.

23. The process as claimed in claim 15, comprising step (C.II), which comprises working up the first aqueous phase by distillative separation of water to retain an alcohol phase, which is followed by a purification of the alcohol phase by distillation or stripping.

24. The process as claimed in claim 1, wherein the isocyanate component comprises methylenediphenylene diisocyanate, polymethylenepolyphenylene polyisocyanate or a mixture of methylenediphenylene diisocyanate and polymethylenepolyphenylene polyisocyanate.

25-31. (canceled)

32. The process as claimed in claim 1, wherein the amine obtained in step (C.I) is phosgenated to afford the corresponding isocyanate in a step (D).

33. The process as claimed in claim 1, wherein the chemolysis is performed at a temperature of 130° C. to 240° C.

34. The process as claimed in claim 1, wherein the catalyst does not include any a quaternary ammonium salt containing an ammonium cation comprising 6 or more carbon atoms, or any organic sulfonate comprising 7 or more carbon atoms.
